(19) United States
(12) Patent Application Publication
(10) Pub. No.: US 2026/0303229 A1
(43) Pub. Date: Oct. 1, 2026

(54) METHOD OF DETERMINING PHASE INFORMATION AND RF DEVICE

(71) Applicant: Infineon Technologies AG, Neubiberg (DE)

(72) Inventors: Alexander BELITZER, München (DE); Stefan SCHMALZL, Sauerlach (DE); Günter MÄRZINGER, Linz (AT); Arianit PRENIQI, Wels (AT)

(21) Appl. No.: 19/442,060

(22) Filed: Jan. 7, 2026

(30) Foreign Application Priority Data
Mar. 27, 2025 (DE) 102025111936.8

(51) Int. Cl. H04B 17/12; H04B 17/10

(52) U.S. Cl. CPC H04B 17/12; H04B 17/101

(57) ABSTRACT

A radio frequency (RF) is configured to determine phase information indicating a phase error of a phase shifter. The phase shifter is arranged in a transmitting path and is configured to apply a phase shift to an RF transmit signal in accordance with a target phase value of a set of target phase values. A processor is configured to process a plurality of sets of measurement values and to determine the phase information indicating the phase error of the phase shifter based on a plurality of sets of measurement values.

### CROSS-REFERENCE TO RELATED APPLICATION

This application claims priority to Germany Patent Application No. 102025111936.8 filed on Mar. 27, 2025, the content of which is incorporated by reference herein in its entirety.

### TECHNICAL FIELD

The present disclosure relates to determining phase information indicating a phase error of a phase shifter.

### BACKGROUND

Radio frequency (RF) circuits in the range from MHz to THz are used in many applications today. For example, RF circuits are used to transmit data in accordance with modern communication protocols or to generate and transmit radar signals for detecting objects. In radar applications, the angle-resolved detection of objects may require the transmission of MIMO signals (MIMO=Multiple In Multiple Out) of different phases via several antennas. The phase setting for each transmitting path can be changed by using a phase shifter capable of shifting phases of the transmitted signals. In each of the above applications, it is desired to set the phase with high precision when transmitting the RF signals in order to avoid unwanted and detrimental effects. In radar applications, for example, an inaccurate phase setting of a transmitting channel can lead to additional spectral components, which can significantly reduce the accuracy of angle detection.

### SUMMARY

According to one aspect, a method of determining phase information indicating a phase error of a phase shifter in a transmitting path of an RF device includes controlling a phase shifter of the transmitting path to apply a phase shift in accordance with a target phase value of a set of target phase values in order to generate an RF transmit signal associated with the target phase value, transmitting the RF transmit signal via the transmitting path, and receiving in a plurality of receiving paths a plurality of RF receive signals, wherein each of the plurality of RF receive signals is associated with a respective receiving path and includes a crosstalk of the respective RF transmit signal into the respective receiving path. The method further includes down-converting the plurality of RF receive signals to generate a plurality of down-converted receive signals, and processing in each receiving path of the plurality of receiving paths the respective down-converted receive signal that is associated with the respective receiving path to generate for each receiving path a measurement value associated with the target phase value applied by the phase shifter.

The method further includes generating a plurality of sets of measurement values wherein each set of the plurality of sets of measurement values is associated with a respective receiving path of the plurality of receiving paths, wherein the plurality of sets of measurement values are generated by repeating the controlling of the phase shifter, the transmitting of the RF transmit signal, the down-converting and the processing in each receiving path in order to generate for each target phase value of the set of target phase values in each respective receiving path a corresponding measurement value of a respective set of measurement values. The phase information is determined based on a processing of the plurality of sets of measurement values.

According to a further aspect, an RF device includes a transmitting path configured to transmit an RF transmit signal via the transmitting path, a phase shifter arranged in the transmitting path and configured to apply a phase shift in accordance with a target phase value of a set of target phase values to the RF transmit signal, and a plurality of receiving paths configured to receive a plurality of RF receive signals including crosstalk of the respective RF transmit signal into the respective receiving path. A plurality of mixers is arranged in the plurality of receiving paths to down-convert the plurality of RF receive signals into a plurality of down-converted receive signals. A controller is configured to control the phase shifter to apply each target phase value of the set of target phase values. The RF device further includes a measurement circuit to generate a plurality of sets of measurement values based on the plurality of down-converted receive signals, wherein each set of the plurality of sets of measurement values is associated with a respective receiving path of the plurality of receiving paths and each measurement value within a set of measurement values is associated with a respective target phase value applied by the phase shifter. The RF device further includes a processor configured to process the plurality of sets of measurement values and to determine phase information indicating a phase error of the phase shifter based on the plurality of sets of measurement values.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1A illustrates a first example of an RF device and cross-talk from a transmitting path to multiple receiving paths of the RF device.

FIG. 1B illustrates a second example of an RF device and cross-talk from a transmitting path to multiple receiving paths of the RF device.

FIG. 1C illustrates a third example of an RF device and cross-talk from a transmitting path to multiple receiving paths of the RF device.

FIGS. 2A, 2B and 2C show examples of measurement values and fitted curves for different receiving paths.

FIGS. 3A, 3B and 3C show examples of sets of measurement phase values and fitted curves for different receiving paths.

FIGS. 4A, 4B and 4C show examples of sets of measurement phase step values and expected target phase step values for different receiving paths.

FIGS. 5A to 5D shows further examples of sets of measurement phase step values for different receiving paths.

FIGS. 6A to 6D shows examples of sets of measurement phase step values after applying a sliding window processing and sets of first derivate values of fitted curves for the measurement phase step values shown in FIGS. 5A to 5D.

FIGS. 7A and 7B show an example of the distribution of measurement phase step values for the measurement phase step values of FIG. 5A and an example of the distribution measurement phase step values after a processing to remove outliers.

FIG. 8 shows an example of a set of combined and averaged measurement phase step values after combining and averaging multiple sets of measurement phase step values.

### DETAILED DESCRIPTION

The examples described herein provide a new concept for determining phase information indicating a phase error of the phase shifter. The concept is based on using crosstalk information from a transmitting path into multiple receiving paths for determining the phase error of phase settings by the phase shifter in the transmitting path. The receiving paths used for determining the phase error are intended to also be used during the field use of the RF device for precise measurements, e.g., for receiving radar signals reflected from radar targets in order to determine range and velocity of the radar targets.

As this concept makes use of the existing receiving paths, it can be implemented without any hardware change in existing RF devices and may require only additional processing or software capabilities and/or small reconfigurations within the multiple receiving paths which can be done on the fly. The concept can be used to obtain a calibration of the phase shifter during one or more calibration time intervals. Calibration time intervals can be scheduled prior the intended operation of the RF device, for example after powering up the RF device or between operation phases of the RF device for example after transmission of a frame of radar chirps.

Besides calibration, the concept can in addition or alternatively be used for monitoring the phase shifter.

In one example, phase errors can be determined for each of a set of predetermined target phase steps. A target phase step is a difference between a pair of target phases (e.g., pair of nearest target phases) that have been applied by the phase shifter.

The concept can be used in any configuration or situation, e.g., in situations where no antennas are connected, in situations where antennas are connected or in situations in which a near-by object reflects crosstalk back to the receiving paths.

The present concept achieves a very high phase measurement accuracy which can improve existing concepts using dedicated built-in measurement circuitry a factor or 4 to 5 times better than. This is achieved in view of the usage of a plurality of receiver paths that are configured also for receiving RF signals during regular operation and which receive crosstalk with different phase delays.

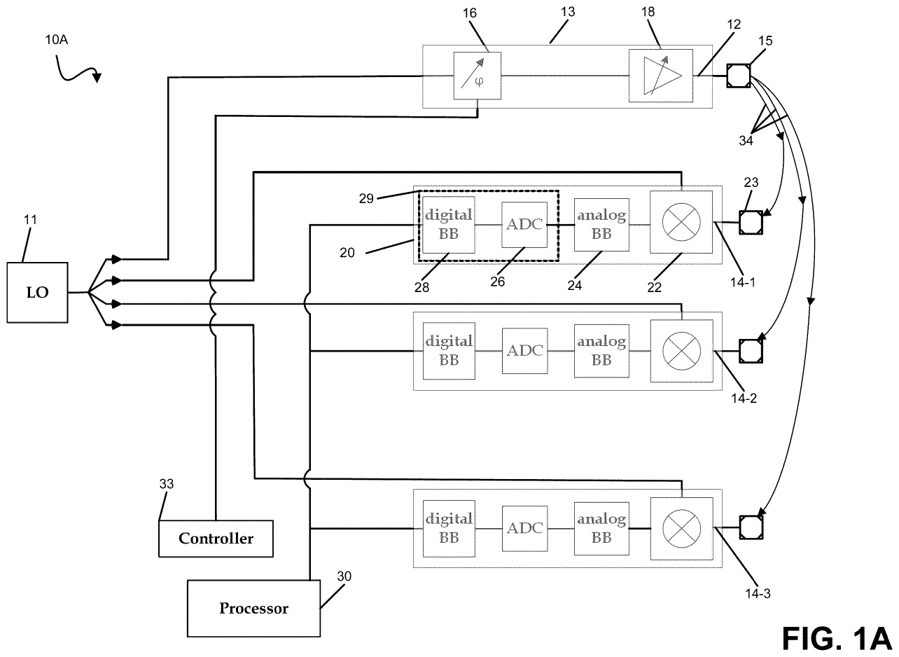

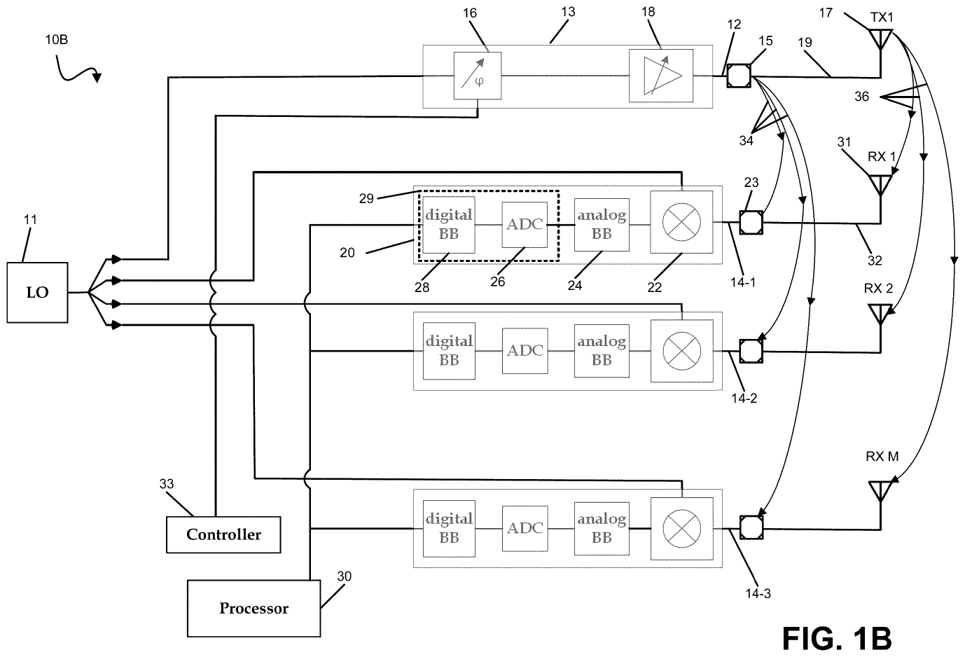

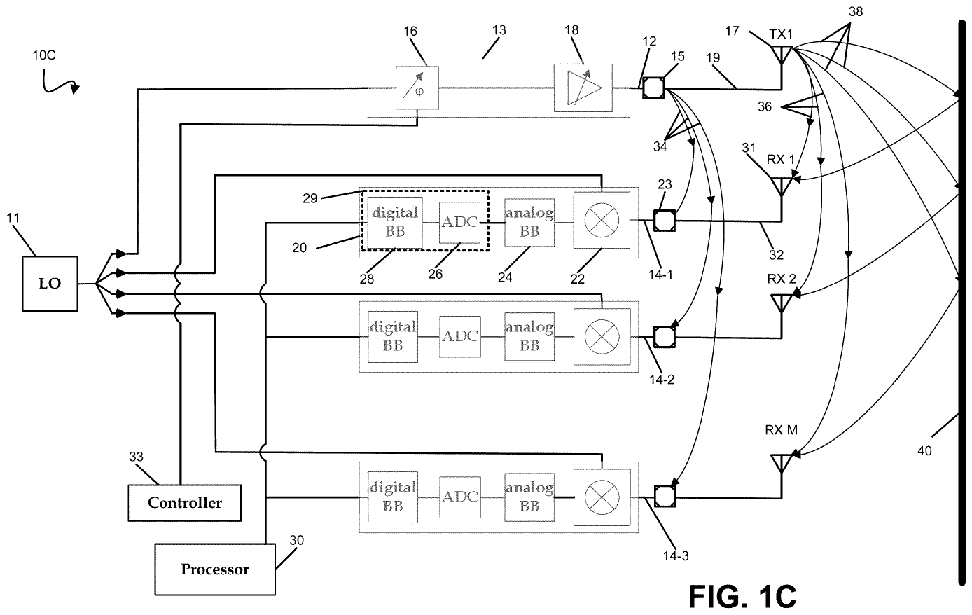

Referring now to FIG. 1a, a first example of an RF device 10A according to the concept will be described. The RF device 10A comprises a transmitting path 12 and a plurality of receiving paths 14-1, 14-2 and 14-3. The transmitting path 12 includes a transmission channel 13 implemented in a semiconductor chip. The transmission channel 13 may include a phase shifter 16. The phase shifter 16 is coupled to a local oscillator (LO) 11 for receiving an LO signal (herein also referred as first representation of the LO signal). The phase shifter 16 is configured to apply a phase shift on the LO signal received from the local oscillator in accordance with a target phase value input from a controller 33 to the phase shifter 16 in order to generate phase shifted signal. The phase shifter 16 may include any type of phase shifters for example analog phase shifters or digital phase shifters. For example, the phase shifter 16 may in one example include an I-Q modulator which is capable to shift a phase by setting amplitudes of the I-path and the Q-path. The phase shifter 16 may in one example include one or more of resistive elements, capacitive elements or inductive elements. The phase shifter 16 may in one example include delay lines and switching elements. The phase shifter 16 is coupled to a power amplifier 18 for amplifying the phase-shifted signal to generate a transmit signal. The transmitting path 12 may also include a port 15 for transferring the transmit signal outside of the semiconductor chip.

Each of the plurality of receiving paths 14-1, 14-2 and 14-3 comprises a respective receiving channel 20 implemented in a semiconductor chip. Each respective receiving channel 20 includes a mixer 22 coupled upstream to a respective port 23 for down-converting receive signals received from the respective port 23. In some examples a low noise amplifier may be arranged between the mixer 22 and the respective port 23. In one example the receiving channel 20 may be implemented as an IQ receiver and the mixer 22 may be implemented as an IQ mixer. Each respective mixer 22 is coupled to the local oscillator 11 for respectively receiving the LO signal (herein also referred as respective representation of the LO signal) used for down-converting the respective receive signal. Each mixer 22 is further coupled downstream to an optional analog baseband circuit 24 for processing the down-converted signal. The analog baseband circuit 24 may for example include an amplifier and/or an analog filter. The analog baseband circuit 24 is coupled downstream to an analog-to-digital converter (ADC) 26 generating digital measurement values based on the received down-converted receive signal. The ADC 26 is coupled downstream to an optional digital baseband circuit 28 for providing digital processing operations for each respective receiving channel 20. The digital baseband circuit 28 may for example include a digital filter, up- or down-sampling circuits etc. The ADC 26 and the optional digital baseband circuit 28 may form a measurement circuit 29 generating measurement values based on the down-converted signal.

Each respective measurement circuit 29 is coupled to a processor 30 for processing the measurement values received from each respective receiving path as will be described later on.

According to some examples, the transmitting channel 13 and each respective receiving channel 20 may be implemented in one semiconductor chip. In some examples, the transmitting channel 13 and the receiving channels 20 may be implemented in different semiconductor chips, for example in semiconductor chips of a cascaded radar system. In some examples, the RF device 10A may include more than one transmitting path 12.

According to some examples, the RF device 10A is a radar device configured to transmit and receive radar signals during a radar operation mode to detect ranges, velocities or angular positions of objects. The radar operation may use for example frequency modulated continuous wave (FMCW) radar signals. Accordingly, the local oscillator 11 is configured to generate FMCW signals during the radar operation mode.

As outlined above, the RF device 10A is configured to determine during a second operation mode phase error information related to phase errors introduced by the phase shifter 16. The phase error information can be determined using only the RF device 10A without any additional hardware elements or circuits. The determining of the phase error information may include reconfigurations such as dynamic modifications or dynamic switching of some elements compared to the intended field operation of the RF device 10A. According to one example, filters in the respective analog baseband circuit 24 and/or digital baseband circuit 28 may be dynamically modified to bypass or eliminate high pass filtering of the down-converted signal during the second operation mode. At an end of the second mode of operation (after finishing calibration and/or monitoring), the high pass filter may again be activated or switched back into the receiving path.

The determining of the phase error information is based on making use of crosstalk from the transmitting path into the plurality of receiving paths 14-1, 14-2 and 14-3. While crosstalk is typically an unwanted signal portion during a radar operation (e.g., in the radar operation mode), the presented concept makes use of the crosstalk signals during the second operation mode to determine the phase error information.

The crosstalk may occur within different sections of the transmitting path 12 and receiving paths 14-1, 14-2 and 14-3. FIG. 1A shows the RF device 10A without transmitting and receiving antennas. In this situation, the crosstalk 34 results mainly from a crosstalk coupling between the port 15 and the respective port 23 of each respective receiving path.

FIG. 1B shows an RF device 10B having the RF device 10A shown in FIG. 1A connected to antennas. Accordingly, the transmitting path 12 further includes a transmission antenna 17 and an antenna path 19 coupled between the transmission antenna 17 and the port 15. Furthermore, each of the plurality of receiving paths 14-1, 14-2 and 14-3 includes a receive antenna 31 and an antenna path 32 coupled between the respective receive antenna 31 and the respective pad 23 for transferring respective receive signals from the receive antenna to the respective port 23. In this example, in addition to the crosstalk 34, a crosstalk 36 resulting from a coupling of the transmit antenna 17 to each respective receive antenna 31 is included in the crosstalk signal.

The transmission antenna 17 may in some examples be a waveguide antenna, a patch antenna or other types of RF antennas. The antenna path 19 may include for example one or more wireless sections and/or one or more wired sections. In some examples the antenna path 19 may include at least one of a waveguide, a strip-line, a substrate integrated waveguide etc. In some examples the antenna path 19 may include elements such as a coupler, a launcher etc. for coupling from one section to another section. Typically the crosstalk signals may result from outside of the semiconductor chips as typically a good RF isolation between transmit and receive channels is provided within the semiconductor chip. The present concept is however not restricted to such situations.

It is to be noted that the concept is not depending on specific crosstalk between specific sections. In fact, crosstalk from multiple crosstalk paths can add up to increase the strength of the crosstalk signal which may be beneficial. Accordingly, in some examples each of the crosstalk signals may comprise crosstalk originating from multiple crosstalk paths. Therefore, the following considerations apply to all situations of crosstalk introduced into the respective receiving paths 14-1, 14-2, 14-3.

The concept can further be used also for signals reflected from a fixed near-by distance to the receiving paths 14-1, 14-2, 14-3. FIG. 1C shows an example in which in addition to the crosstalk 34 and 36 indirect signals 38 resulting from a reflection of the transmit signals from a near-by object 40 are reflected back to the receiving paths 14-1, 14-2, 14-3. For using the above described concept in such situation, the distance of the near-by object 40 to the receiving paths 14-1, 14-2 and 14-3 needs to be fixed. The near-by object 40 may for example be a metal wall that is arranged at a fixed distance. FIG. 1C shows an RF device 10C similar to the RF device 10B shown in FIG. 1B placed before the object 40 at a fixed distance for reflecting the transmit signal back to the respective receiving paths. The above described can be applied in a similar manner to such situations.

According to one example, the local oscillator 11 is controlled in the second mode of operation to generate a continuous wave signal having one fixed RF frequency. For example, the RF frequency may be selected to be between 20 and 100 GHZ.

In case the RF system includes more than one transmitting channel 13, respective other transmit channels are controlled to not transmit during the measurement described above such that cross-talk resulting from only one transmitting channel is introduced into the receiving paths 14-1, 14-2 and 14-3. After completing the determining of the phase information for the transmitting channel 13, each of the other transmitting channels may then be sequentially activated in order to determine the phase information for the respective other transmitting channels.

In order to determine the phase error information, the controller 33 is configured to control the phase shifter 16 to sequentially apply target phase values from a set of target phase values. It is to be noted that in some examples the controller 33 may be implemented fully or partially in the processor 30 using for example software executed by the processor 30 to generate the set of target phase values.

The transmit channel 20 generates in accordance with the applied target phase value a respective RF transmit signal associated with the target phase value. The transmit signal is transmitted via the transmitting path 12. In each of the receiving paths 14-1, 14-2 and 14-3, the respective RF receive signal including the respective crosstalk from the RF transmitting path 12 into the respective RF receiving path is received and down-converted by the respective mixer 22. The down-converted signal is processed by the analog baseband circuit 24 and converted into a digital measurement value using the analog-to-digital converter 26.

In one example, the measurement value represents the DC value of the down-converted signal. In a radar operation, DC portions of the down-converted signal are typically filtered out using a high-pass filter in the analog baseband circuit and/or digital baseband circuit. However, in the second mode, the respective receiving path is reconfigured such that the high-pass filter is bypassed or does not apply low-frequency filtering in order to allow the DC value of the down-converted signal to be measured.

For each of the target phase values applied by the phase shifter 16, a corresponding measurement value is generated in each of the plurality of receiving paths 14-1, 14-2, 14-3. Accordingly, a plurality of sets of measurement values is generated where each set is associated with one of the receiver paths 14-1, 14-2, 14-3. Each measurement value of a set of measurement values is associated with one target phase setting of the set of target phase setting. According to one example, the set of target phase values includes regular spaced target phase values between 0 and 360° which may be determined by

$$φ = \frac{n}{N} 360 ° ,$$

where N is an integer number and n is an integer number running from 0 and N−1.

The plurality of sets of measurement values is then processed by the processor 30 to determine the phase information.

According to one example, the processor 30 may arrange the set of measurements in an order so that the target phase corresponding a measurement value is continuously increasing in case the target phase values have not been applied in an increasing order.

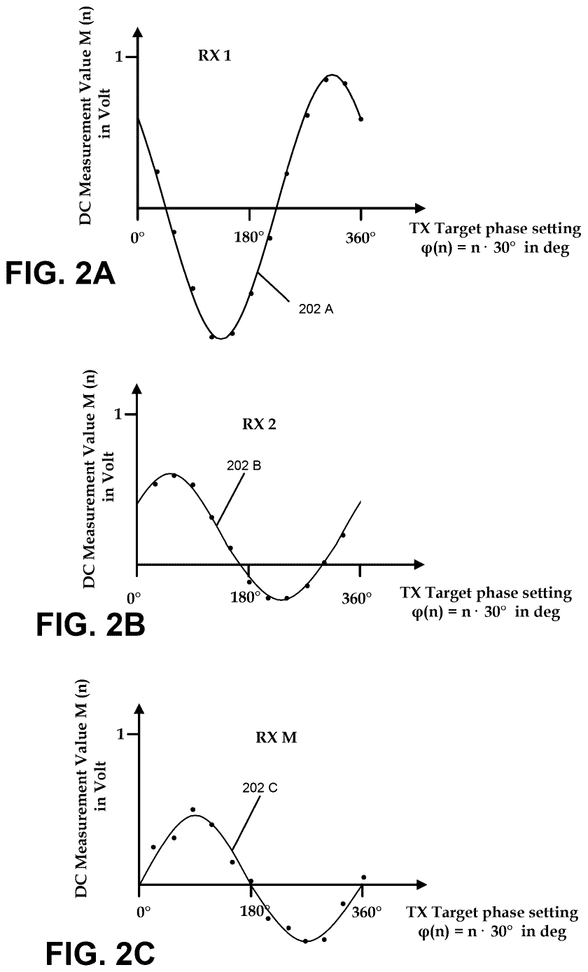

FIGS. 2A to 2C show for the receiving paths 14-1, 14-2 and 14-3 an illustrative example of a plurality of sets of measurement values for twelve target phase values. FIG. 2A corresponds to the receiving path 14-1, FIG. 2B corresponds to the receiving path 14-2 and FIG. 2C corresponds to the receiving path 14-3. The measurement values (DC values) are shown as dots in the respective FIG. 2A to 2C.

For continuous wave signals, the DC value of the down-converted signal for each measurement can be described by

$$M ( n ) = A sin ( 360 ° \frac{n}{N} + ϕ er r ( n ) + ϕ ) + B ,$$

where A is the amplitude of the respective sinusoidal curve matching the DC values, B is a DC-Offset of the respective sinusoidal curve matching the DC values and φerr(n) is the phase error introduced by the phase shifter when applying the target phase value 360° n N and φ is the phase introduced by the of the cross-talk signal with respect to the LO signal received at the mixer 22. Note that the phase φ introduced by the cross-talk is different for each receiving path as the length of the crosstalk paths are different. However for one receiving path, the phase φ can be assumed to be constant for all measurement values as the crosstalk scenario and length of the crosstalk paths typically will not change within a measurement period (which can range from hundreds of microseconds to milliseconds) which for applications including automotive applications can be assumed to be sufficiently satisfied. Note that in the absence of a phase error introduced by the phase shifter 16, the measurement values are expected to be located precisely on a sine curve (assuming no measurement errors).

For each set of measurement values M(n), a fitting sine curve can be determined using the processor 30 in order to determine fitted values for the parameters A, B and φ. Values for the parameters A and/or B and/or φ or information representing values for the parameters A and/or B and/or φ may herein also be referred to as information indicating the parameters A and/or B and/or φ. The fitting sine curve can be determined, for example, by minimizing an error function

$$E ( n ) = {\vert M ( n ) - A sin ( 360 ° \frac{n}{N} + ϕ ) + B \vert}^{2}$$

for the parameters A, B and φ.

In some examples the values for the parameters A, B and φ can be determined using the processor 30 by Fourier transforming the set of measurement values M(n) where the 0^{th} order frequency component (DC component) indicates the offset B, the magnitude of the third order frequency component provides A and the phase of the third order frequency component provides φ.

FIGS. 2A to 2C shows illustrative examples of fitting sine curves 202A, 202B, and 202C matching the respective set of measurement values.

Having determined the fitting sine curve and/or the values for parameters A and B, the processor 30 can calculate a plurality of sets of measurement phase values from the plurality of sets of measurement values M(n) by using the inverse sine function (arcsin) to obtain

$$φ ( n ) = arcsin ( \frac{M ( n ) - B}{A} )$$

and applying to each respective measurement value M(n).

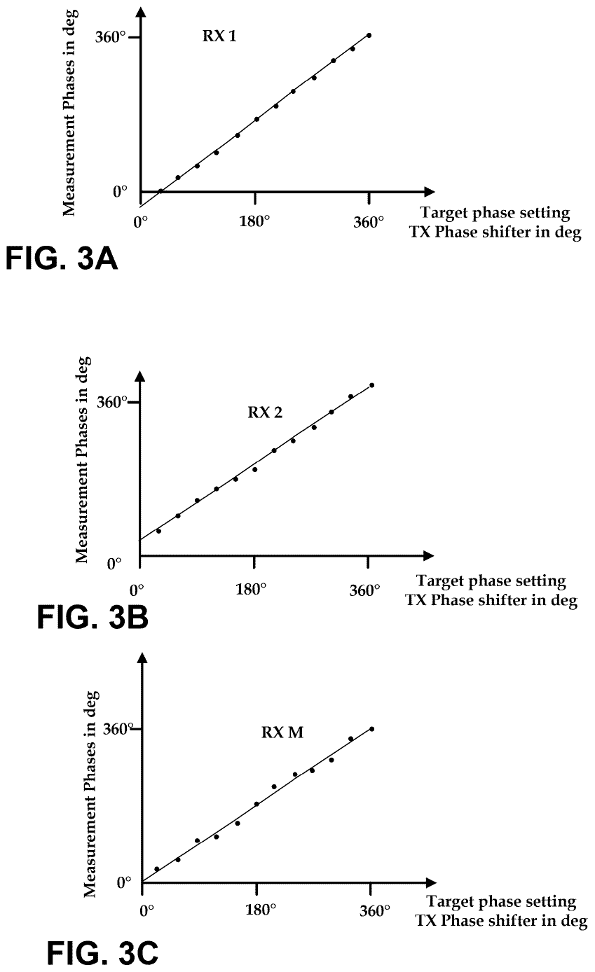

FIGS. 3A to 3C show an illustrative example of the plurality of sets of measurement phase values (shown as dots) and corresponding curves fitting each set of measurement phase values. It can be noted that the fitted curves have a same slope but different offsets in view of the different cross-coupling paths for each receiving path.

From the plurality of sets of measurement phase values, a plurality of sets of measurement phase step values can be calculated by determining respective pairs of measurement phase values within a respective set of measurement phase values and calculating a difference between the respective measurement phase values of each pair. According to one example, the processor 30 determines pairs of neighbor measurement phase values, φ(n) and φ(n+1), and uses the following equation for determining a respective measurement phase step value φstep(n):

$$φ step ( n ) = φ ( n ) - ϕ ( n + 1 ) = arcsin ( \frac{M ( n ) - B}{A} ) - arcsin ( \frac{M ( n + 1 ) - B}{A} ) . \qquad ( Equation 1 )$$

As understood herein, a neighbor measurement phase value of a respective measurement phase value is the measurement phase value of a measurement value that corresponds to a target phase value that is from all target phase values closest to the target phase value of the respective measurement phase value. A phase step value associated with a target phase value (e.g., index n) therefore represents the phase difference between the measurement phase value associated with the target phase value (e.g., index n) and a phase value associated with the neighbor target phase value (e.g., index n+1).

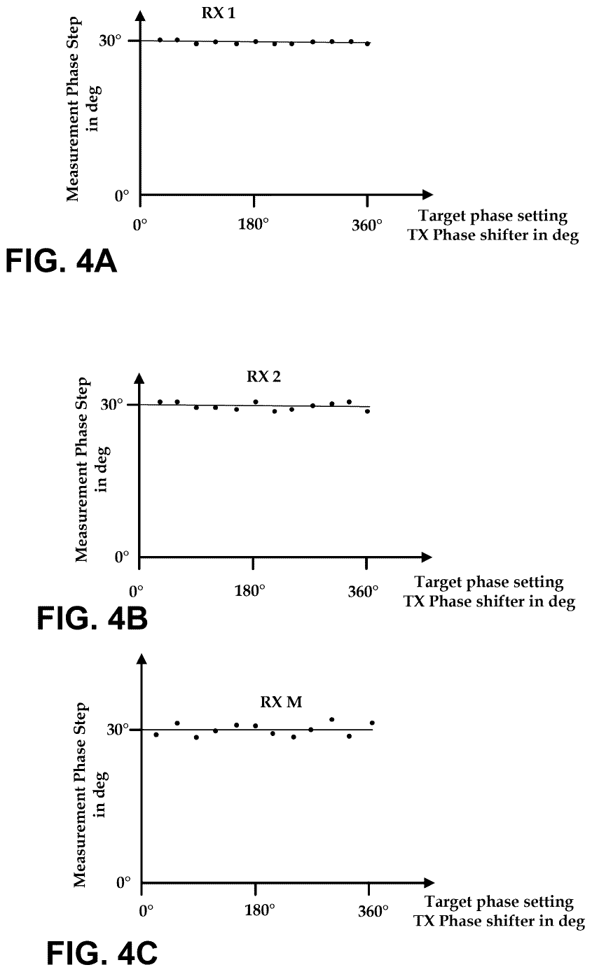

FIGS. 4A to 4C show an illustrative example of a plurality of sets of measurement phase step values determined using equation 1. In addition, FIGS. 4A to 4C show the expected target phase step value which is the difference between a pair of target phase values, for example between two consecutive target phase values which in this case is 360°/12=30°. Assuming no phase errors are introduced by the phase shifter 16 and no measurement errors or other processing errors are present, each phase step value of each set of phase step values determined using Equation 1 would be calculated to be exactly the target phase step value.

In case the phase shifter 16 introduces a phase error, each set of the measurement phase step values will follow the phase step error curve of the phase shifter 16 if no measurement errors are present. In case measurement errors or other processing errors are present, the measurement phase step values are dithering around the phase error curve of the phase shifter 16.

The dithering (deviation between the measurement phase step values and the expected phase step error curve) may in some examples depend on the target phase values associated with the measurement phase step value. In particular it has been observed that in a region in which the fitted sine curve has a maximum, the accuracy of the measurement is decreased as a small deviation of the measurement value due to measurement errors leads to a deviation of the determined phase value. This can also be seen from equation 1 as same requires to subtract a first arcsine value from a second arcsine value. As the absolute value of the derivative of an arcsine function approaches infinity at 90° and 270° (extrema of the sine curve), any measurement error of a measurement value which is close to the extrema of the sine curve fitting the set of measurement values will significantly influence the result of equation 1. Moreover, the influence of measurement errors or processing errors on the result gets stronger when both measurement values of equation 1 are close to the extremum of the respective sinusoidal fitting curve.

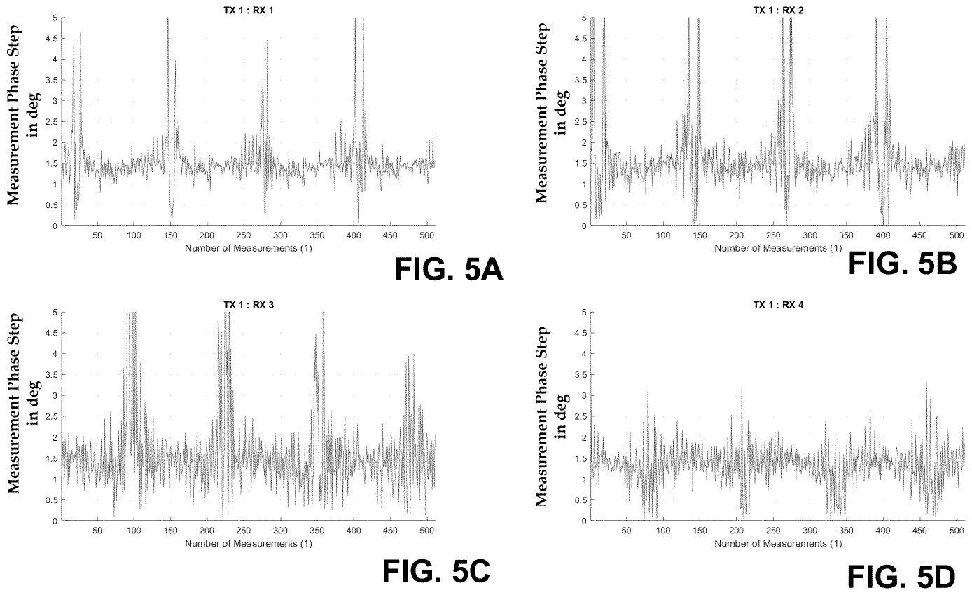

FIGS. 5A to 5D show a plurality of sets of measurement phase step values resulting from actual measurements in four receiving paths RX1, RX2, RX3 and RX4 with a target phase step value of 360/256=1,40625°. Furthermore, it is to be noted that the measurement was done with a calibrated phase shifter so that no errors are introduced by the phase shifter and the measurement phase step values are expected to be the target phase step value. It is to be noted that in the measurement of FIGS. 5A to 5D the target phase applied by the phase shifter 16 is turned consecutively two times from 0 to 360° in steps of 1,40625°⁰ (target phase step value). Each of FIGS. 5A to 5D shows therefore a set of 512 measurement phase step values and measurement number i and measurement number 256+i correspond to a same target phase applied by the phase shifter 16.

FIG. 5A shows the set of measurement phase step values corresponding to the receiving path RX1. As can be observed from FIG. 5A, the measurement phase step values show increased fluctuations in regions between measurement numbers 10 to 40, 135 to 165, 265 to 295 and 395 to 425. Similar behavior can be observed in FIGS. 5B to 5D, however in different regions.

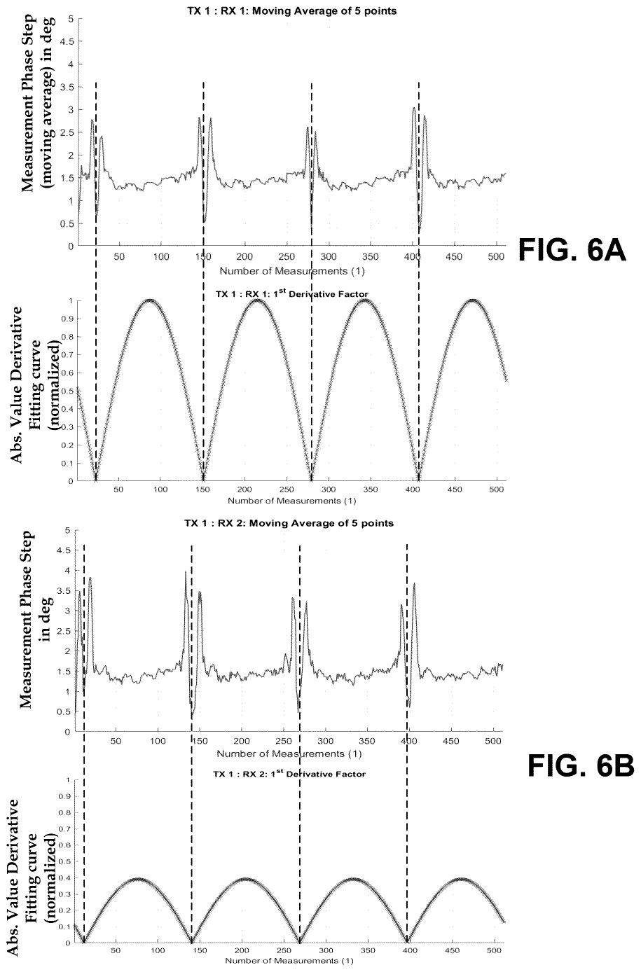

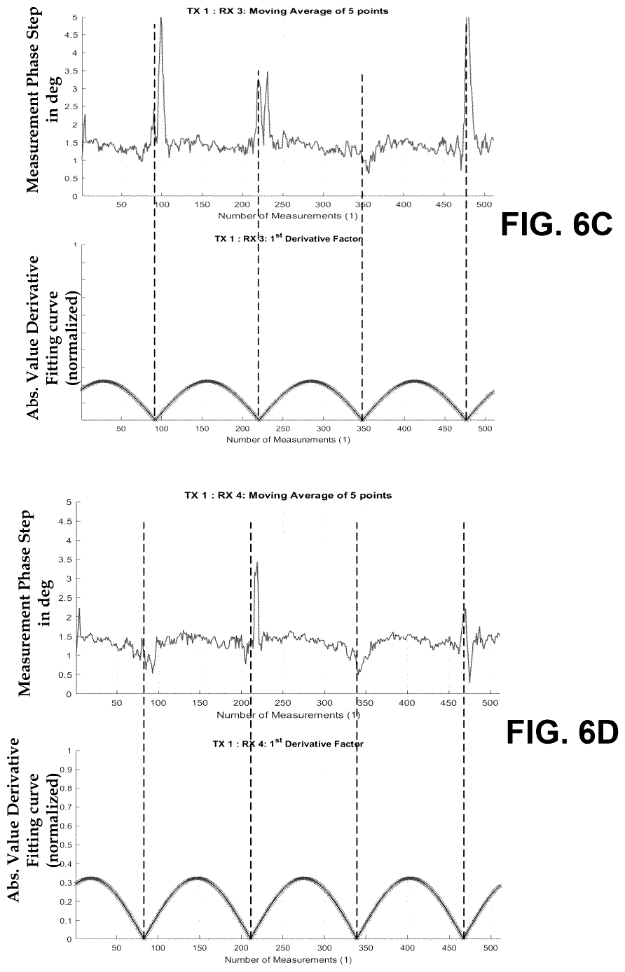

FIGS. 6A to 6D show in the respective upper diagram the plurality of sets of measurement phase step values after a moving average processing of 5 points. In the respective lower diagram of FIGS. 6A to 6D, the absolute value of the derivative of the fitted sine curve fitting the respective set of measurement values is shown. As can be observed the increased fluctuation in the measurement phase step value corresponds to a zero of the derivative of the respective fitting curve. In other words, the increased fluctuations appear in regions where the respective fitting curve of the measurement values is close to an extremum.

However, due to the fact that the extrema of the fitted sine curves are located at different target phase values for the plurality of receiving paths, a combination of the sets of measurement phase step values can provide an accurate measurement of the measurement phase step value for all target phase values as will be outlined below in more detail.

According to one example, the plurality of sets of measurement phase step values are processed by combining one or more of the sets of measurement phase step values using weighting factors. According to one example a weighting factor wⱼ(n) may be determined for each n indicating the target phase value (running from 1 to N) and each j indicating a respective receiving path. According to one example, a weighted sum may be calculated using the weighting factor wⱼ(n) according to

$${φ}_{s t e p} ( n ) = \frac{{\sum }_{j = 1}^{J} {w}_{j} ( n ) {φ}_{s t e {p}_{j}} ( n )}{{\sum }_{j = 1}^{J} {w}_{j} ( n )} ,$$

where J is the number of receiving paths used for the calculation, j is the index of a respective receiving path and φₛₜₑₚ_{ⱼ}(n) is the respective measurement phase step value.

According to some examples, the weighting factor wⱼ(n) may be determined based on the fitted sine curve M_{fitting} by using slope information (first derivative) of the sine curve at the respective target phase value φ(n). A value of the derivative of the fitted curve may herein be considered as one example of a fitted derivative value. According to one example, the weighting factor wⱼ(n) may be determined as the absolute value of the first derivative at the respective target phase value

$${w}_{j} ( n ) = \vert \frac{d Mfitting}{d φ} {\vert}_{φ = φ ( n )} \vert ,$$

the square of the first derivative

$${w}_{j} ( n ) = {( \frac{d Mfitting}{d φ} {\vert}_{φ = φ ( n )} )}^{2}$$

or polynomials of degree 1,2 or higher having the first derivative as variable.

In some examples, the slope information may include a value assigned to a region of slopes. For example, for a first region around a extremum of the fitted sine curves, a same value for the weighting factor wⱼ(n) may be assigned while for regions outside of the extremum one or more other values for the weighting factor weighting factor wⱼ(n) may be assigned.

According to some examples, the weighting factor wⱼ(n) may be determined based on statistical information of each set of measurement phase step values. According to some examples, the statistical information may be dispersion information indicating a measure of dispersion of the measurement phase step values within the respective set of measurement phase step values.

According to some examples, the weighting factor wⱼ(n) may be determined based on a distance of each measurement phase step values from a median or average value. In some examples, the weighting factor wⱼ(n) may be set to zero in case a respective measurement phase step value lies outside of specific boundaries, for example outside the 20^{th} and 80^{th} percentiles of the set of measurement phase step values.

According to some examples, the weighting factor wⱼ(n) is based on a magnitude of the down-converted signal which can be determined for example by the amplitude A of the fitting curve for each receiving path. In some examples, the weighting factor wⱼ(n) may be based on a DC offset of the down-converted signal which can be determined for example by the offset B of the fitting curve for each receiving path.

According to some examples, the weighting factor may be based on a combination of a statistical information and/or amplitude and/or a measurement DC offset. According to one example the weighting factor may be determined according to wⱼ(n)=Aⱼσⱼ, or wⱼ(n)=Bⱼσⱼ, or

$${w}_{j} ( n ) = \frac{{A}_{j} {σ}_{j}}{B j} ,$$

where σⱼ is the standard deviation of the respective set of measurement phase step values corresponding to the receiving path j, Aⱼ. is the amplitude of the fitting curve corresponding to receiving path j, and Bⱼ is the measurement DC offset of the fitting curve corresponding to the receiving path j as described above.

According to some examples, the combination of the sets of measurement phase step values includes a removing of outliers prior to an averaging of the measurement phase step values.

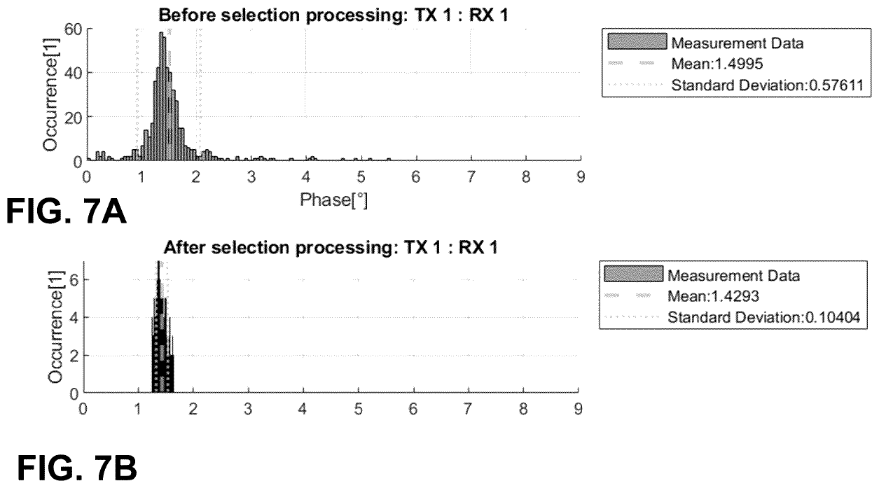

FIG. 7A shows a distribution of the measurement phase step values of the set corresponding to the receiving path RX1. It can be observed that the average calculated phase step value is 1.4995° and the standard deviation of the set of measurement phase step values is determined to be 0.57611. FIG. 7B shows a distribution of the same set of calculated measurement phase step values with a pre-selection in which outliers outside of the 20^{th} and 80^{th} percentile are removed prior to the processing. The average calculated phase step value is reduced to 1.4293° which is much closer to the expected value of 1.4062°. Furthermore, the standard deviation is reduced to 0.10404 which indicates the improvement obtained by removing outliers.

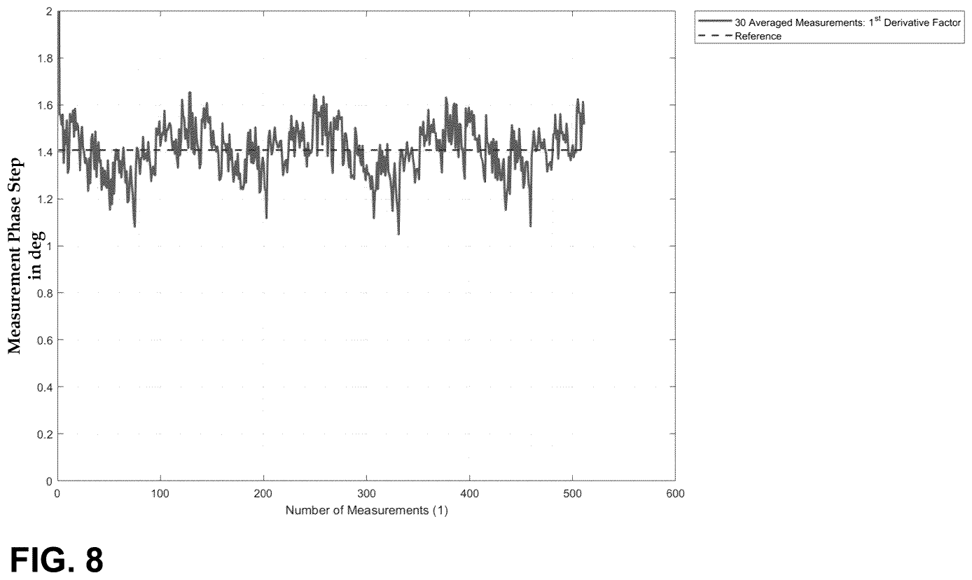

FIG. 8 shows a set of measurement phase step values which includes measurement first phase step values generated using weighting factors determined using

$${w}_{j} ( n ) = \vert \frac{d Mfitting}{d φ} {\vert}_{φ = φ ( n )} \vert$$

and averaged over 30 measurements.

A phase step error of the phase shifter 16 can be determined for each target phase value by comparing the respective measurement phase step value with the target phase value (e.g., by subtracting the respective measurement phase step value from the target phase value). In this manner, a phase step error curve of the phase shifter 16 for the various target phase values can be established.

Note that in the measurements, the phase error was approximately zero as the phase shifter 16 used in the measurements was pre-calibrated. It can be observed from FIG. 8 that the phase step values are determined to be very close to the expected target phase step value (dashed line) with an accuracy of +/−0.3°. This shows the high accuracy of the concept for determining the actual phase step error applied by the phase shifter when the target phase value is changed from a first value to a second value or a corresponding error of the actual phase step introduced by the phase shifter.

In addition to the above examples, the following examples are disclosed herein.

According to one example, a method of determining phase information indicating a phase error of a phase shifter in a transmitting path of an RF device involves a series of acts to measure and calculate the phase information. The method begins by controlling a phase shifter of the transmitting path to apply a phase shift in accordance with a target phase value of a set of target phase values, which may refer to a predetermined range of phase values, in order to generate an RF transmit signal associated with the target phase value. This RF transmit signal is then transmitted via the transmitting path.

The RF transmit signal is received as crosstalk in a plurality of receiving paths, where each receiving path receives a respective RF receive signal that comprises a crosstalk of the respective RF transmit signal into the respective receiving path. Crosstalk may refer to direct transfer of energy from the transmitting path to a respective receiving path or a transfer of energy from the transmitting path to a respective receiving path via a close-by reflecting object. The plurality of RF receive signals are then down-converted to generate a plurality of down-converted receive signals. Down-converting may refer to the process of converting a high-frequency signal to a lower-frequency signal.

In each receiving path, the respective down-converted receive signal is processed to generate a measurement value associated with the target phase value applied by the phase shifter. This processing may involve various signal processing techniques, such as filtering or amplification.

A plurality of sets of measurement values are generated by repeating the controlling of the phase shifter, the transmitting of the RF transmit signal, the down-converting, and the processing for each receiving path. Each set of measurement values is associated with a respective receiving path and is generated for each target phase value of the set of target phase values.

The phase information is then determined based on processing the plurality of sets of measurement values. This processing may involve various algorithms and techniques, such as curve fitting Fourier-Transformation or interpolation, to extract the phase information from the measurement values.

In one implementation, the RF transmit signal is a continuous wave RF signal having a fixed frequency and/or the set of target phase values includes each phase value φn=360° n N, N is a number equal or greater than 4 and n is a number from 1 to N. This allows to have regularly spaced target phase values which allows to efficiently use processing techniques such as Fourier-Transformation, curve fitting etc.

In a further implementation, determining the phase information includes processing the plurality of sets of measurement values to calculate a plurality of sets of measurement phase values.

In a further implementation, determining the phase information comprises: processing each set of measurement values to determine first information indicating an amplitude, A, and offset, B, of a respective sinusoidal curve matching the respective set of measurement values, and processing the respective set of measurement values in order to generate the plurality of sets of measurement phase values. Processing the respective set of measurement values may include for example applying a function arcsin((M(m) −B)/A) to each respective measurement value M.

In a further implementation, processing each set of measurement values to determine the first information comprises at least one of the following acts: Fourier-Transforming the set of measurement values to determine the first information, or fitting a sinusoidal curve to determine the first information.

In a further implementation, determining the phase information comprises: processing the plurality of sets of measurement phase values to generate a plurality of sets of measurement phase step values. Each respective set of phase step values is calculated by determining pairs of respective measurement phase values within a respective set of measurement phase values and calculating a difference between the respective measurement phase values of each pair, combining two or more of the sets of measurement phase step values to generate a set of first phase step values.

In a further implementation, combining two or more of the sets of measurement phase step values includes determining for each measurement phase step value of the plurality of sets of measurement phase step values a respective weighting factor and combining the plurality of sets of measurement phase step values using the respective weighting factor for each measurement phase step value to determine the set of first phase step values.

In a further implementation, determining a respective weighting factor includes at least one of: determining amplitude information, determining slope information for each measurement phase value or determining dispersion information. The amplitude information indicates an amplitude of each respective RF receive signal. The slope information indicates information on a difference between a respective measurement phase value and a neighbor measurement phase value or indicate a derivative of a curve fitting a respective set of measurement phase values. The dispersion information may indicate a measure of dispersion related to a respective set of measurement phase step values. The respective weighting factor is determined based on at least one of the amplitude information, slope information or dispersion information.

In a further implementation, combining two or more of the sets of measurement phase step values to generate a set of first phase step values includes processing the plurality of sets of measurement phase step values to determine whether the measurement phase step value is an outlier or not, and in case one or more outliers are identified, removing one or more measurement phase step values corresponding to the one or more identified outliers from the respective set of measurement phase step values.

In a further implementation, processing the plurality of sets of measurement phase step values to determine whether the measurement phase step value is an outlier or not comprises: processing the plurality of sets of measurement phase step values by applying a statistical function to each set of measurement phase step values in order to generate statistical information, and using the statistical information to determine for each measurement phase step value whether the respective measurement phase step value is an outlier or not. The statistical information may for example include percentile information, for example a 20-80 percentile information.

A further implementation includes comparing the first phase step values to a target phase step value in order to determine the phase information, where the target phase step value is a difference between a pair of target phase values.

A further implementation includes at least one of the following acts: determining calibration information based on the phase information or using the calibration information during operation of the RF device.

According to a further example, an RF device comprises a transmitting path configured to transmit an RF transmit signal via the transmitting path, a phase shifter arranged in the transmitting path and configured to apply a phase shift in accordance with a target phase value of a set of target phase values to the RF transmit signal, and a plurality of receiving paths configured to receive a plurality of RF receive signals including crosstalk of the respective RF transmit signal into the respective receiving path. A plurality of mixers is arranged in the plurality of receiving paths to down-convert the plurality of RF receive signals into a plurality of down-converted receive signals. A controller is configured to control the phase shifter to apply each target phase value of the set of target phase values a measurement circuit to generate a plurality of sets of measurement values based on the plurality of down-converted receive signals, wherein each set of the plurality of sets of measurement values is associated with a respective receiving path of the plurality of receiving paths and each measurement value within a set of measurement values is associated with a respective target phase value applied by the phase shifter. The RF device further includes a processor configured to process the plurality of sets of measurement values and to determine phase information indicating a phase error of the phase shifter based on the plurality of sets of measurement values.

In one implementation of the RF device, the transmitting path is configured to generate the RF transmit signal as a continuous wave RF signal having a fixed frequency and/or the controller is configured to control the phase shifter to apply each target phase value φ(n)=3600 n/N where N is a number equal or greater than 4 and n is a number from 1 to N.

In a further implementation, the measurement circuit is configured to determine for each receiving path of the plurality of receiving paths a respective direct current value of the down-converted receive signal as a respective measurement value.

In a further implementation, the processor is configured to process the plurality of sets of measurement values to calculate a plurality of sets of measurement phase values.

In a further implementation, the processor is configured to process each set of measurement values to determine first information indicating an amplitude, A, and offset, B, of a respective sinusoidal curve matching the respective set of measurement values, and the processor is further configured to process the set of measurement values in order to generate the plurality of sets of measurement phase values. Processing the set of measurement values may in one example include applying a function arcsin((M(m) −B)/A) to each respective measurement value M(m).

In a further implementation, the processor is configured to process each set of measurement values to determine the first information by at least one of the following processing acts: Fourier-Transforming the set of measurement values to determine the first information, or fitting a sinusoidal curve to determine the first information.

In a further implementation, the processor is configured to process the plurality of sets of measurement phase values to generate for each receiving path a respective set of measurement phase step values of a plurality of sets of measurement phase step values. The processors is configured to generate a respective set of phase step values based on determining pairs of respective measurement phase values and calculating a difference between the respective measurement phase values of each pair, and to combine two or more of the sets of measurement phase step values to generate a set of first phase step values.

In a further implementation, the processor is configured to combine two or more of the sets of measurement phase step values by determining for each measurement phase step value of the plurality of sets of measurement phase step values a respective weighting factor, and combining the plurality of sets of measurement phase step values using the respective weighting factor for each measurement phase step value to determine the first phase steps value.

In a further implementation of the RF according to the second aspect, the processor is configured to determine at least one of the following information: amplitude information, slope information or dispersion information. The amplitude information may indicate an amplitude of each respective RF receive signal, the slope information indicates for each measurement phase value, a difference between a respective measurement phase value and a neighbor measurement phase value or may indicate a derivative of a curve fitting a respective set of measurement phase values, and the dispersion information may indicate a measure of dispersion related to a respective set of measurement phase step values. The processor is further configured to determine the weighting factor based on at least one of the amplitude information, slope information or dispersion information.

In a further implementation, the processor is configured to: process the plurality of sets of measurement phase step values to determine whether the measurement phase step value is an outlier or not, and in case one or more outliers are identified, removing one or more measurement phase step values corresponding to the identified one or more outliers from the respective set of measurement phase step values.

In a further implementation, the processor is configured to: process the plurality of sets of measurement phase step values by applying a statistical function to each set of measurement phase step values in order to generate statistical information, and to apply the statistical information to determine for each measurement phase step value whether the respective measurement phase step value is an outlier.

In a further implementation, the RF device is further configured to determine calibration information based on the phase information and using the calibration information during an operation of the RF device, and/or monitoring the phase information during an operation of the RF device.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

In a further implementation of the method according to the second aspect, the processor is configured to process each set of measurement values to determine the first information by at least one of the following processing acts: Fourier-Transforming the set of measurement values to determine the first information, or fitting a sinusoidal curve to determine the first information.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the invention, as well as specific examples thereof, are intended to encompass equivalents thereof.

### ASPECTS

The following provides an overview of some Aspects of the present disclosure:

Aspect 1: A method of determining phase information indicating a phase error of a phase shifter in a transmitting path of a radio frequency (RF) device, the method comprising: controlling a phase shifter of the transmitting path to apply a phase shift in accordance with a target phase value of a set of target phase values in order to generate an RF transmit signal associated with the target phase value, transmitting the RF transmit signal via the transmitting path, receiving in a plurality of receiving paths a plurality of RF receive signals, wherein each of the plurality of RF receive signals is associated with a respective receiving path and comprises a crosstalk of the respective RF transmit signal into the respective receiving path, down-converting the plurality of RF receive signals to generate a plurality of down-converted receive signals, in each receiving path of the plurality of receiving paths, processing the respective down-converted receive signal associated with the respective receiving path to generate for each receiving path a measurement value associated with the target phase value applied by the phase shifter, generating a plurality of sets of measurement values wherein each set of the plurality of sets of measurement values is associated with a respective receiving path of the plurality of receiving paths, wherein the plurality of sets of measurement values are generated by repeating the controlling of the phase shifter, the transmitting of the RF transmit signal, the down-converting and the processing in each receiving path in order to generate for each target phase value of the set of target phase values in each respective receiving path a corresponding measurement value of a respective set of measurement values, and determining the phase information based on processing the plurality of sets of measurement values.

Aspect 2: The method according to Aspect 1, wherein the RF transmit signal is a continuous wave RF signal having a fixed frequency and/or the set of target phase values includes each phase value φn=360° nN, wherein N is a number equal or greater than 4 and n is a number from 1 to N.

Aspect 3: The method according to any of Aspects 1-2 wherein the processing in each receiving path of the plurality of receiving paths comprises: determining for each receiving path of the plurality of receiving paths a respective direct current, DC, value of the down-converted receive signal as a respective measurement value associated with the respective target phase value applied by the phase shifter.

Aspect 4: The method according to any of Aspects 1-3, wherein determining the phase information comprises: processing the plurality of sets of measurement values to calculate a plurality of sets of measurement phase values, wherein each set of measurement phase values is associated with one of the plurality of receiving paths and wherein each measurement phase value within a respective set of measurement phase values is associated with a corresponding measurement value and indicates a measured phase value of the crosstalk into the respective receiving path.

Aspect 5: The method according to Aspect 4, wherein determining the phase information comprises: processing each set of measurement values to determine first information indicating an amplitude and offset of a respective sinusoidal curve matching the respective set of measurement values, and processing the respective set of measurement values in order to generate the plurality of sets of measurement phase values.

Aspect 6: The method according to Aspect 5, wherein processing each set of measurement values to determine the first information comprises at least one of the following acts: Fourier-Transforming the set of measurement values to determine the first information, or fitting a sinusoidal curve to determine the first information.

Aspect 7: The method according to Aspect 4, wherein determining the phase information comprises: processing the plurality of sets of measurement phase values to generate a plurality of sets of measurement phase step values, wherein each respective set of phase step values is calculated by determining pairs of respective measurement phase values within a respective set of measurement phase values and calculating a difference between the respective measurement phase values of each pair, combining two or more of the sets of measurement phase step values to generate a set of first phase step values.

Aspect 8: The method according to Aspect 7, wherein combining two or more of the sets of measurement phase step values comprises: determining for each measurement phase step value of the plurality of sets of measurement phase step values a respective weighting factor, combining the plurality of sets of measurement phase step values using the respective weighting factor for each measurement phase step value to determine the set of first phase step values.

Aspect 9: The method according to Aspect 8, wherein determining a respective weighting factor comprises at least one of: determining amplitude information indicating an amplitude of each respective RF receive signal, determining slope information, wherein the slope information indicates information on a difference between a respective measurement phase value and a neighbor measurement phase value or indicates a derivative of a curve fitting a respective set of measurement phase values and determining the respective weighting factor based on the slope information, determining dispersion information indicating a measure of dispersion related to a respective set of measurement phase step values and determining the weighting factor based on the dispersion information, and determining the respective weighting factor based on at least one of the amplitude information, slope information or dispersion information.

Aspect 10: The method according to Aspect 7, wherein combining two or more of the sets of measurement phase step values to generate a set of first phase step values comprises: processing the plurality of sets of measurement phase step values to determine whether the measurement phase step value is an outlier or not, and in case one or more outliers are identified, removing one or more measurement phase step values corresponding to the one or more identified outliers from the respective set of measurement phase step values.

Aspect 11: The method according to Aspect 10, wherein processing the plurality of sets of measurement phase step values to determine whether the measurement phase step value is an outlier or not comprises: processing the plurality of sets of measurement phase step values by applying a statistical function to each set of measurement phase step values in order to generate statistical information, and using the statistical information to determine for each measurement phase step value whether the respective measurement phase step value is an outlier or not.

Aspect 12: The method according to Aspect 10, further comprising: comparing the first phase step values to a target phase step value in order to determine the phase information, where the target phase step value is a difference between a pair of target phase values.

Aspect 13: The method according to any of Aspects 1-12, further comprising at least one of: determining calibration information based on the phase information and using the calibration information during operation of the RF device, or monitoring the phase information during an operation of the RF device.

Aspect 14: A radio frequency (RF) device, comprising: a transmitting path configured to transmit an RF transmit signal via the transmitting path, a phase shifter arranged in the transmitting path and configured to apply a phase shift to the RF transmit signal in accordance with a target phase value of a set of target phase values, a plurality of receiving paths configured to receive a plurality of RF receive signals comprising crosstalk of the respective RF transmit signal into the respective receiving path, a plurality of mixers arranged in the plurality of receiving paths to down-convert the plurality of RF receive signals into a plurality of down-converted receive signals, a controller configured to control the phase shifter to apply each target phase value of the set of target phase values a measurement circuit to generate a plurality of sets of measurement values based on the plurality of down-converted receive signals, wherein each set of the plurality of sets of measurement values is associated with a respective receiving path of the plurality of receiving paths and each measurement value within a set of measurement values is associated with a respective target phase value applied by the phase shifter, and a processor configured to process the plurality of sets of measurement values and to determine phase information indicating a phase error of the phase shifter based on the plurality of sets of measurement values.

Aspect 15: The RF device according to Aspect 14, wherein the transmitting path is configured to generate the RF transmit signal as a continuous wave RF signal having a fixed frequency and/or wherein the controller is configured to control the phase shifter to apply each target phase value φ(n)=360° (n/N) where N is a number equal or greater than 4 and n is a number from 1 to N.

Aspect 16: The RF device according to any of Aspects 14-15, wherein the measurement circuit is configured to determine for each receiving path of the plurality of receiving paths a respective direct current, DC, value of the down-converted receive signal as a respective measurement value.

Aspect 17: The RF device according to any of Aspects 14-16, wherein the processor is configured to process the plurality of sets of measurement values to calculate a plurality of sets of measurement phase values, wherein each set of measurement phase values is associated with one of the plurality of receiving path and wherein each measurement phase value indicates a measured transmit phase value corresponding to the respective measurement value.

Aspect 18: The RF device according to Aspect 17, wherein the processor is configured to process each set of measurement values to determine first information indicating an amplitude, A, and offset, B, of a respective sinusoidal curve matching the respective set of measurement values, and wherein the processor is further configured to process the set of measurement values in order to generate the plurality of sets of measurement phase values.

Aspect 19: The RF device according to Aspect 18, wherein the processor is configured to process each set of measurement values to determine the first information by at least one of the following processing acts: Fourier-Transforming the set of measurement values to determine the first information, or fitting a sinusoidal curve to determine the first information.

Aspect 20: The RF device according to Aspect 17, wherein the processor is configured to process the plurality of sets of measurement phase values to generate for each receiving path a respective set of measurement phase step values of a plurality of sets of measurement phase step values, wherein the processor is configured to generate a respective set of phase step values based on determining pairs of respective measurement phase values and calculating a difference between the respective measurement phase values of each pair, and wherein the processor is configured to combine two or more of the sets of measurement phase step values to generate a set of first phase step values.

Aspect 21: The RF device according to Aspect 20, wherein the processor is configured to combine two or more of the sets of measurement phase step values by determining for each measurement phase step value of the plurality of sets of measurement phase step values a respective weighting factor, and combining the plurality of sets of measurement phase step values using the respective weighting factor for each measurement phase step value to determine the first phase steps value.

Aspect 22: The RF according to Aspect 21, wherein the processor is configured to determine at least one of the following information: amplitude information indicating an amplitude of each respective RF receive signal slope information for each measurement phase value, wherein the slope information indicates a difference between a respective measurement phase value and a neighbor measurement phase value or indicates a derivative of a curve fitting a respective set of measurement phase values, dispersion information indicating a measure of dispersion related to a respective set of measurement phase step values and wherein the processor is further configured to determine the weighting factor based on at least one of the amplitude information, slope information or dispersion information.

Aspect 23: The RF device according to Aspect 20, wherein the processor is configured to: process the plurality of sets of measurement phase step values to determine whether the measurement phase step value is an outlier or not, and in case one or more outliers are identified, removing one or more measurement phase step values corresponding to the identified one or more outliers from the respective set of measurement phase step values.

Aspect 24: The RF device according to Aspect 23, wherein the processor is configured to: process the plurality of sets of measurement phase step values by applying a statistical function to each set of measurement phase step values in order to generate statistical information, and to apply the statistical information to determine for each measurement phase step value whether the respective measurement phase step value is an outlier.

Aspect 25: The RF device according to any of Aspects 14-24, further configured to determine calibration information based on the phase information and using the calibration information during an operation of the RF device, and/or monitoring the phase information during an operation of the RF device.

Aspect 26: A system configured to perform one or more operations recited in one or more of Aspects 1-25.

Aspect 27: An apparatus comprising means for performing one or more operations recited in one or more of Aspects 1-25.

Aspect 28: A non-transitory computer-readable medium storing a set of instructions, the set of instructions comprising one or more instructions that, when executed by a device, cause the device to perform one or more operations recited in one or more of Aspects 1-25.

Aspect 29: A computer program product comprising instructions or code for executing one or more operations recited in one or more of Aspects 1-25.

1. A method of determining phase information indicating a phase error of a phase shifter in a transmitting path of a radio frequency (RF) device, the method comprising:
controlling a phase shifter of the transmitting path to apply a phase shift in accordance with a target phase value of a set of target phase values in order to generate an RF transmit signal associated with the target phase value,
transmitting the RF transmit signal via the transmitting path,
receiving in a plurality of receiving paths a plurality of RF receive signals, wherein each of the plurality of RF receive signals is associated with a respective receiving path and comprises a crosstalk of the respective RF transmit signal into the respective receiving path,
down-converting the plurality of RF receive signals to generate a plurality of down-converted receive signals,
in each receiving path of the plurality of receiving paths, processing the respective down-converted receive signal associated with the respective receiving path to generate for each receiving path a measurement value associated with the target phase value applied by the phase shifter,
generating a plurality of sets of measurement values wherein each set of the plurality of sets of measurement values is associated with a respective receiving path of the plurality of receiving paths, wherein the plurality of sets of measurement values are generated by repeating the controlling of the phase shifter, the transmitting of the RF transmit signal, the down-converting and the processing in each receiving path in order to generate for each target phase value of the set of target phase values in each respective receiving path a corresponding measurement value of a respective set of measurement values, and
determining the phase information based on processing the plurality of sets of measurement values.

2. The method according to claim 1, wherein the RF transmit signal is a continuous wave RF signal having a fixed frequency and/or the set of target phase values includes each phase value
$$φ ( n ) = 360 ° \frac{n}{N} ,$$
wherein N is a number equal or greater than 4 and n is a number from 1 to N.

3. The method according to claim 1 wherein the processing in each receiving path of the plurality of receiving paths comprises:
determining for each receiving path of the plurality of receiving paths a respective direct current value of the down-converted receive signal as a respective measurement value associated with the respective target phase value applied by the phase shifter.

4. The method according to claim 1, wherein determining the phase information comprises:
processing the plurality of sets of measurement values to calculate a plurality of sets of measurement phase values, wherein each set of measurement phase values is associated with one of the plurality of receiving paths and wherein each measurement phase value within a respective set of measurement phase values is associated with a corresponding measurement value and indicates a measured phase value of the crosstalk into the respective receiving path.

5. The method according to claim 4, wherein determining the phase information comprises:
processing each set of measurement values to determine first information indicating an amplitude and offset of a respective sinusoidal curve matching the respective set of measurement values, and
processing the respective set of measurement values in order to generate the plurality of sets of measurement phase values.

6. The method according to claim 5, wherein processing each set of measurement values to determine the first information comprises at least one of the following acts:
Fourier-Transforming the set of measurement values to determine the first information, or
fitting a sinusoidal curve to determine the first information.

7. The method according to claim 4, wherein determining the phase information comprises:
processing the plurality of sets of measurement phase values to generate a plurality of sets of measurement phase step values, wherein each respective set of phase step values is calculated by determining pairs of respective measurement phase values within a respective set of measurement phase values and calculating a difference between the respective measurement phase values of each pair,
combining two or more of the sets of measurement phase step values to generate a set of first phase step values.

8. The method according to claim 7, wherein combining two or more of the sets of measurement phase step values comprises:
determining for each measurement phase step value of the plurality of sets of measurement phase step values a respective weighting factor,
combining the plurality of sets of measurement phase step values using the respective weighting factor for each measurement phase step value to determine the set of first phase step values.

9. The method according to claim 8, wherein determining a respective weighting factor comprises at least one of:
determining amplitude information indicating an amplitude of each respective RF receive signal,
determining slope information, wherein the slope information indicates information on a difference between a respective measurement phase value and a neighbor measurement phase value or indicates a derivative of a curve fitting a respective set of measurement phase values and determining the respective weighting factor based on the slope information,
determining dispersion information indicating a measure of dispersion related to a respective set of measurement phase step values and determining the weighting factor based on the dispersion information, and
determining the respective weighting factor based on at least one of the amplitude information, slope information or dispersion information.

10. The method according to claim 7, wherein combining two or more of the sets of measurement phase step values to generate a set of first phase step values comprises:
processing the plurality of sets of measurement phase step values to determine whether the measurement phase step value is an outlier or not, and
in case one or more outliers are identified, removing one or more measurement phase step values corresponding to the one or more identified outliers from the respective set of measurement phase step values.

11. The method according to claim 10, wherein processing the plurality of sets of measurement phase step values to determine whether the measurement phase step value is an outlier or not comprises:
processing the plurality of sets of measurement phase step values by applying a statistical function to each set of measurement phase step values in order to generate statistical information, and
using the statistical information to determine for each measurement phase step value whether the respective measurement phase step value is an outlier or not.

12. The method according to claim 10, further comprising:
comparing the first phase step values to a target phase step value in order to determine the phase information, where the target phase step value is a difference between a pair of target phase values.

13. The method according to claim 1, further comprising at least one of:
determining calibration information based on the phase information and using the calibration information during operation of the RF device, or
monitoring the phase information during an operation of the RF device.

14. A radio frequency (RF) device, comprising:
a transmitting path configured to transmit an RF transmit signal via the transmitting path,
a phase shifter arranged in the transmitting path and configured to apply a phase shift to the RF transmit signal in accordance with a target phase value of a set of target phase values,
a plurality of receiving paths configured to receive a plurality of RF receive signals comprising crosstalk of the respective RF transmit signal into the respective receiving path,
a plurality of mixers arranged in the plurality of receiving paths to down-convert the plurality of RF receive signals into a plurality of down-converted receive signals,
a controller configured to control the phase shifter to apply each target phase value of the set of target phase values
a measurement circuit to generate a plurality of sets of measurement values based on the plurality of down-converted receive signals, wherein each set of the plurality of sets of measurement values is associated with a respective receiving path of the plurality of receiving paths and each measurement value within a set of measurement values is associated with a respective target phase value applied by the phase shifter, and
a processor configured to process the plurality of sets of measurement values and to determine phase information indicating a phase error of the phase shifter based on the plurality of sets of measurement values.

15. The RF device according to claim 14, wherein the transmitting path is configured to generate the RF transmit signal as a continuous wave RF signal having a fixed frequency and/or wherein the controller is configured to control the phase shifter to apply each target phase value
$$φ ( n ) = 360 ° \frac{n}{N}$$
where N is a number equal or greater than 4 and n is a number from 1 to N.

16. The RF device according to claim 1, wherein the measurement circuit is configured to determine for each receiving path of the plurality of receiving paths a respective direct current value of the down-converted receive signal as a respective measurement value.

17. The RF device according to claim 14, wherein the processor is configured to process the plurality of sets of measurement values to calculate a plurality of sets of measurement phase values, wherein each set of measurement phase values is associated with one of the plurality of receiving path and wherein each measurement phase value indicates a measured transmit phase value corresponding to the respective measurement value.

18. The RF device according to claim 17, wherein the processor is configured to process each set of measurement values to determine first information indicating an amplitude and offset of a respective sinusoidal curve matching the respective set of measurement values, and wherein the processor is further configured to process the set of measurement values in order to generate the plurality of sets of measurement phase values.

19. The RF device according to claim 18, wherein the processor is configured to process each set of measurement values to determine the first information by at least one of the following processing acts:
Fourier-Transforming the set of measurement values to determine the first information, or
fitting a sinusoidal curve to determine the first information.

20. The RF device according to claim 17, wherein the processor is configured to process the plurality of sets of measurement phase values to generate for each receiving path a respective set of measurement phase step values of a plurality of sets of measurement phase step values, wherein the processor is configured to generate a respective set of phase step values based on determining pairs of respective measurement phase values and calculating a difference between the respective measurement phase values of each pair, and
wherein the processor is configured to combine two or more of the sets of measurement phase step values to generate a set of first phase step values.

21. The RF device according to claim 20, wherein the processor is configured to combine two or more of the sets of measurement phase step values by determining for each measurement phase step value of the plurality of sets of measurement phase step values a respective weighting factor, and combining the plurality of sets of measurement phase step values using the respective weighting factor for each measurement phase step value to determine the first phase steps value.

22. The RF according to claim 21, wherein the processor is configured to determine at least one of the following information:
amplitude information indicating an amplitude of each respective RF receive signal
slope information for each measurement phase value, wherein the slope information indicates a difference between a respective measurement phase value and a neighbor measurement phase value or indicates a derivative of a curve fitting a respective set of measurement phase values,
dispersion information indicating a measure of dispersion related to a respective set of measurement phase step values
and wherein the processor is further configured to determine the weighting factor based on at least one of the amplitude information, slope information or dispersion information.

23. The RF device according to claim 20, wherein the processor is configured to:
process the plurality of sets of measurement phase step values to determine whether the measurement phase step value is an outlier or not, and
in case one or more outliers are identified, removing one or more measurement phase step values corresponding to the identified one or more outliers from the respective set of measurement phase step values.

24. The RF device according to claim 23, wherein the processor is configured to:
process the plurality of sets of measurement phase step values by applying a statistical function to each set of measurement phase step values in order to generate statistical information, and
to apply the statistical information to determine for each measurement phase step value whether the respective measurement phase step value is an outlier.

25. The RF device according to claim 14, further configured to determine calibration information based on the phase information and using the calibration information during an operation of the RF device, and/or monitoring the phase information during an operation of the RF device.
